(19) United States
(12) Patent Application Publication
(10) Pub. No.: US 2010/0036147 A1
(43) Pub. Date: Feb. 11, 2010

(54) INTEGRATED COLLECTION, ANALYSIS, AND RECYCLING METHOD

(75) Inventors: Brian L. Jones, Midland, MI (US); Jeffrey Hempfling, Midland, MI (US); Angela Doherty Barondeau, Crestwood, KY (US)

Correspondence Address: JAMES D. STEVENS;REISING ETHINGTON P.C., P.O. BOX 4390, TROY, MI, 48099, US

(73) Assignee: DOW CORNING CORPORATION, Midland, MI (US)

(21) Appl. No.: 12/443,701

(22) PCT Filed: Oct. 2, 2007
(86) PCT No.: PCT/US07/80149

§ 371 Date: Mar. 31, 2009

Related U.S. Application Data
(60) Provisional application No. 60/893,225, filed on Mar. 6, 2007.
(60) Provisional application No. 60/827,769, filed on Oct. 2, 2006.

(51) Int. Cl. G06F 19/00; C07F 7/02

(52) U.S. Cl. 556/466; 702/23; 700/266

(57) ABSTRACT

A recycling method that can be used by an OEM products company or other entity to obtain recovered raw materials for use in its manufacturing operations in a manner that helps ensure the quality and traceability of the recovered raw materials. The process involves first collecting the material from one or more sources, then determining suitability of the material for processing using a series of qualifying tests separated into a two-phase review, wherein each of the qualifying tests is carried out using a composition profile for the material. The first phase of the review utilizes a source composition profile that describes salient features of the material so that it can be reviewed for suitability for processing and end uses as well as for regulatory compliance. The second phase involves similar reviews based on an analytical composition profile that is determined by physical analysis of the material.

### TECHNICAL FIELD

The present invention relates generally to recycling of materials and, in particular, to techniques for overall management of material recycling from identification and collection through conversion and reuse of the materials. This invention also particularly relates to such techniques as they are applied to the recycling and reuse of silicones.

### BACKGROUND OF THE INVENTION

The benefits of recycling of materials is well known, and there is typically a benefit both to the environment and to the particular manufacturing entities which use the materials since they can often benefit from cost savings as a result of the reuse of scrap materials. The different recycling approaches used for different materials or applications of a material can vary significantly depending upon such things as the particular material involved and the requirements of the manufacturer for reuse of the material. Different types of materials can be recovered in different ways, sometimes dependent upon the form in which the scrap is received. For example, some materials can be recovered using relatively simple physical separation, whereas others may require more complicated processing involving chemical separation and conversion into different forms.

Silicones, which are generally considered herein as compositions containing functionally effective amounts of siloxane, can be recycled by a materials conversion process in which the scrap silicone material is cracked using a catalyst. Techniques are known for catalyst cracking of the scrap silicone to break it down into smaller molecules so that it can be converted back into a usable raw material such as, for example, dimethyl silicone oil. Depending upon the material to be recycled, the conversion process, contamination levels, and other such factors, the recycling of silicones and other materials can be categorized to assist in identifying the appropriate subsequent uses of the recycled materials; for example, as virgin material or as suitable for a blended end product. This is typically handled on an ad-hoc basis. Often, the overall recycling process involves different parties (scrap supplier, collector, conversion processor, and subsequent buyer) located in different parts of the world (e.g., scrap collected from the U.S. is sent to China for recycling, and then shipped as raw material to Europe or back to the U.S.). Since the recycled material is typically categorized according to its acceptability for certain uses, purchasers of the recycled material must either rely on the recycler's categorization of the material or perform testing of the materials received.

This introduces a technical problem in the recycling process; namely, how to produce usable recovered components from scrap silicone. With the current ad-hoc approach to the overall recycling process, recovered material from the recycling process may not be usable for certain products or applications of the manufacturer. For example, without proper assessment, tracking, and processing of the scrap silicone, the recoverable components may not be usable as virgin material in high grade applications even though the scrap starting material was of a quality and condition that could support such high grade uses. Accordingly, there is a need for an integrated assessment and recycling process which can produce recovered components from scrap silicone and other materials that produces recycled components that are usable by the manufacturer for higher grade applications.

Apart from the problem of how to produce components usable for certain (e.g., high grade) applications, another technical problem that exists today in the recycling industry is how to identify waste material at the start of the process that can be used to recover components usable for a particular end product or application. Without this ability, it may not be possible to determine whether the waste stream from a particular generator of that waste will support recycling of the waste into components usable for a particular end use.

### SUMMARY OF THE INVENTION

In accordance with one aspect of the invention, there is provided a method of validating a material for recycling into a least one raw material. The method includes the steps of:

(a) collecting the material from one or more sources;

(b) determining suitability of the material for processing using a series of qualifying tests separated into a two-phase review, wherein each of the qualifying tests involves determining at least a pass or fail result based on a composition profile for the material;

wherein a first phase of the two-phase review includes the steps of:
(c1) obtaining a source composition profile for the material;
(c2) assessing regulatory compliance for the material based on the source composition profile; and
(c3) assessing acceptability of the material components based on the source composition profile; and

wherein a second phase of the two-phase review includes the steps of:
(d1) obtaining an analytical composition profile for the material based on a physical analysis of the material;
(d2) assessing regulatory compliance for the material based on the analytical composition profile; and
(d3) assessing acceptability of the material components based on the analytical composition profile; and

(e) rejecting the material for processing if a fail result is determined by any of the qualifying tests and, if no fail result is obtained, then passing the material as validated and suitable for processing.

In accordance with another aspect of the invention, there is provided a method of recycling a material to obtain at least one recycled component suitable for use in a predetermined end product, comprising the steps of:

collecting the material;

assessing the material using a plurality of qualifying tests at least one of which is carried out according to one or more requirements relating to the predetermined end product;

obtaining from the material at least one component usable in the predetermined end product based on the outcome of the qualifying tests; and

producing the predetermined end product using the component.

In accordance with yet another aspect of the invention, there is provided a method of recycling silicones comprising:

collecting scrap silicone;

assessing the scrap silicone for the presence of a sufficient siloxane content, safety for recycling, the presence of a hazardous component and the potential for an unusable byproduct in a conversion process;

converting the scrap silicones to form a reusable component with a predetermined profile; and

reusing the reusable component.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is an overview of the different stages and groups involved in carrying out the disclosed recycling method;

FIG. 2 is a flowchart depicting the workflows used to carry out the four stage recycling method of FIG. 1;

FIG. 3 is flowchart showing an particular implementation of the stage 2 processing of FIG. 1; and

FIG. 4 is a flowchart showing further detail of the compositional review and regulatory review steps of FIG. 3.

### DETAILED DESCRIPTION OF THE PREFERRED EMBODIMENTS

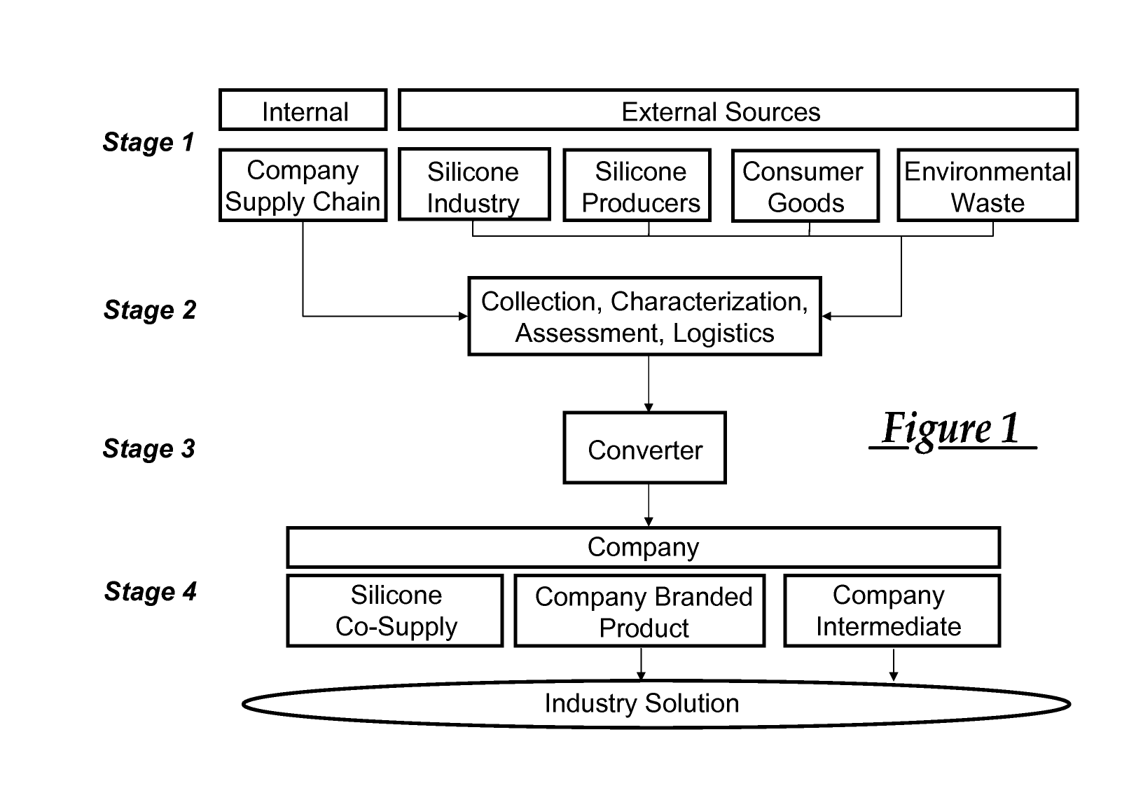

FIGS. 1-4 depict an exemplary embodiment of an overall recycling process as it might be used by a manufacturer such as an OEM products company to recycle its and others' scrap materials back into raw materials that are then inserted into the production chain for use in manufacturing new products. Although this description is being given in conjunction with silicone reclamation, it will be understood by those skilled in the art that the process can be adapted for use in other industries in conjunction with other materials. As used herein, converting a recyclable material into a “raw material” means that the recycled material has been physically or chemically processed to either extract certain components of the recycled material or to convert it to another form or substance, or to remove contaminants or other undesired components of the material.

FIG. 1 shows an overview of the different groups and stages in the overall recycling process. In general, sources of silicone within and without the company can be utilized. This can include scrap silicone from internal company operations or from outside sources, such as others within the same industry, other silicone producers for another industry, or from consumer goods and environmental waste. It will also be appreciated that the process need not require silicone supplied from all of these sources, just one or more. The scrap and waste silicone materials are collected, characterized, assessed, and put into a recycling supply chain. Logistical management of these functions allows for downstream planning of the distribution and use of the recycled materials, enables the realization of efficiencies due to bulk aggregation and handling of like materials, and aids in tracking and documentation of the individual sources of waste and scrap material.

The next stage is the actual processing and conversion of the scrape/waste to raw materials, which will often include not only cracking of the silicones, but additional treatment to achieve the desired forms of the raw materials (e.g., as oils or rubbers or more viscous forms). The various processes used to convert silicones back to a usable raw material form are known to those skilled in the art. Once this has been done, the recycled silicone is then put back into the material supply chain which can include supplying it to other manufacturers or back to the company for use as a silicone co-supply or to provide an end product used for industry solutions—either as a branded product or as an intermediate.

Typically, the various stages are implemented by different parties; for example, some or all of the collection, characterization, assessment, and management of these functions would be handled by an environmental services company (ESC). Similarly, the converters are typically separate entities that may be located in different global locations than the company and ESCs. As one example, the silicone manufacturer (company) and ESC may be U.S. based entities, whereas the converter may be located in China or India. By utilizing the stage 2 functions, the process allows an ordered, repeatable, and documented approach to managing the initial collection, characterization, and handling of the waste/scrap silicone. Furthermore, by integrating all of the stages and their processing steps into a managed collection of workflows, the process enables the users to properly classify, track, and certify the recycled materials which helps eliminate uncertainty in the handling and chain of custody of the processed materials. This can help insure proper regulatory compliance and documentation as well as providing for more standardized profiling of the waste/scrap material.

Implementation of the recycling process can be carried out by the company itself, with the different entities involved being responsible to carry out their respective functions according to a set of business rules specified by the company. This allows franchising by the company of at least some of the functions in the recycling process. For example, the converters can be franchisees approved by the company to carry out the materials conversion process. These and other recycling process steps can be carried out by franchisees located in secondary geographic markets.

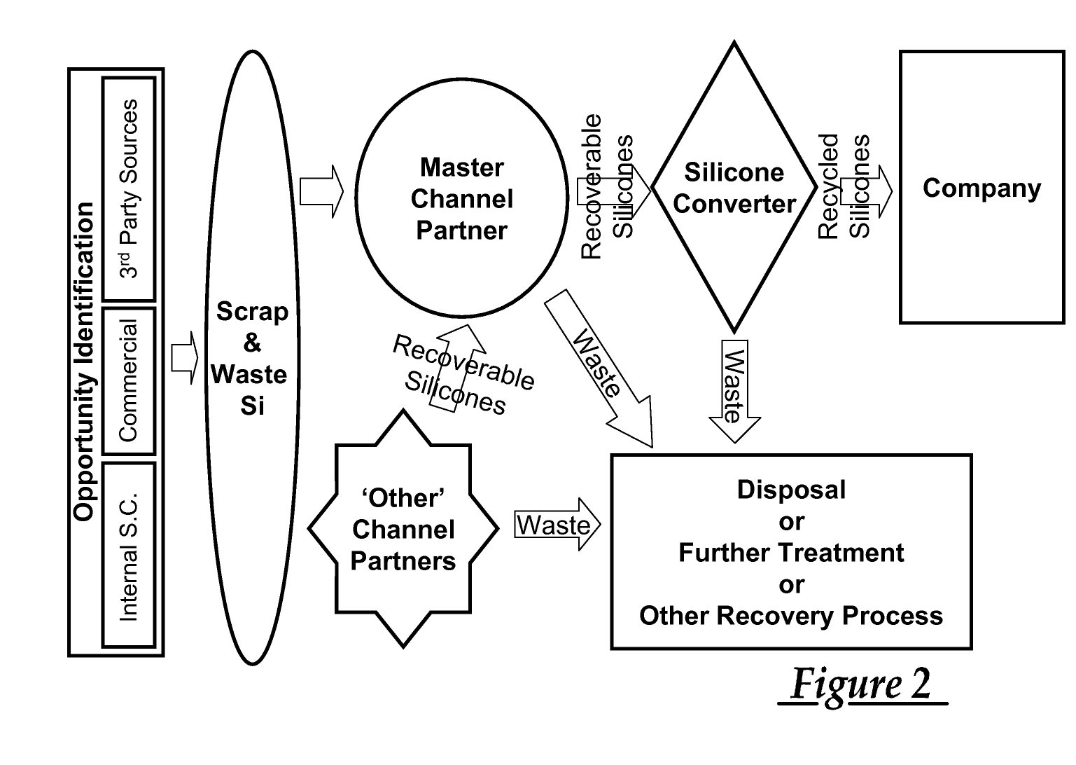

Referring now to FIG. 2, there is shown a flowchart of the work flows involved in the using the four stage recycling approach of FIG. 1. The first step is to identify opportunities for sourcing of the silicone scrap and/or waste. For the company that is managing the overall recycling process, the silicone materials can come from the company's internal supply chain, its commercial operations, or other (third party) sources. The scrap and waste silicone is then collected by a master channel partner which can be an ESC that has the responsibility of collection, characterization, assessment, and distribution of the material to one or more silicone converters. Recoverable silicones can also be supplied to the master channel partner from other channel partners (that is, from other companies or sources looking to recycle scrap and waste silicone). The master channel partner handles the stage 2 functions noted above; namely, collecting scrap/waste silicone, characterizing the material based on its composition, assessing its suitability for recycling, and then distributing the recoverable material to the converters, all while managing the logistics of the process. After processing by one or more converters, the resulting recycled silicones are returned to the company for re-use in its products and operations. Alternatively, the recycled silicones can be distributed to other manufactures or into other distribution channels.

At each of the intermediate stages, the process may produce or identify waste material that cannot be reclaimed as a part of the silicone conversion process. In some instances, this waste is the result of a particular supply of scrap silicone material not being approved for conversion due to, for example, it containing a hazardous contaminant. In other cases, the waste may be an unusable byproduct of the conversion process itself. In either case, this waste material is then handled as appropriate by the channel partner or converter, whether that be by disposal or by using other treatment or recovery processes. Non-silicone recoverable materials reclaimed by the converter from the waste material can be distributed to manufacturers or the waste material itself can be sent for subsequent recovery processes.

One advantage of the integrated recycling process disclosed herein is that, rather than the recycling process being carried out by a single manufacturer for their own internal purposes, or by different parties on an ad-hoc and disconnected basis, this integrated approach allows for the use of predefined, consistent processes for the collection, characterization, assessment, tracking, and handling of the recycled silicones. This provides a level of reliability in the process that both the waste generators and end users (consumers) of the recycled silicone can rely on and allows the ESC acting as master channel partner to provide the generators, converters and end users with standardized profiling of the compositions, assistance with applicable regulations, as well as documentation of all aspects of the recycling process, including that related to the material composition, tracking of particular supplies of the scrap/waste through the system, and the conversion process itself.

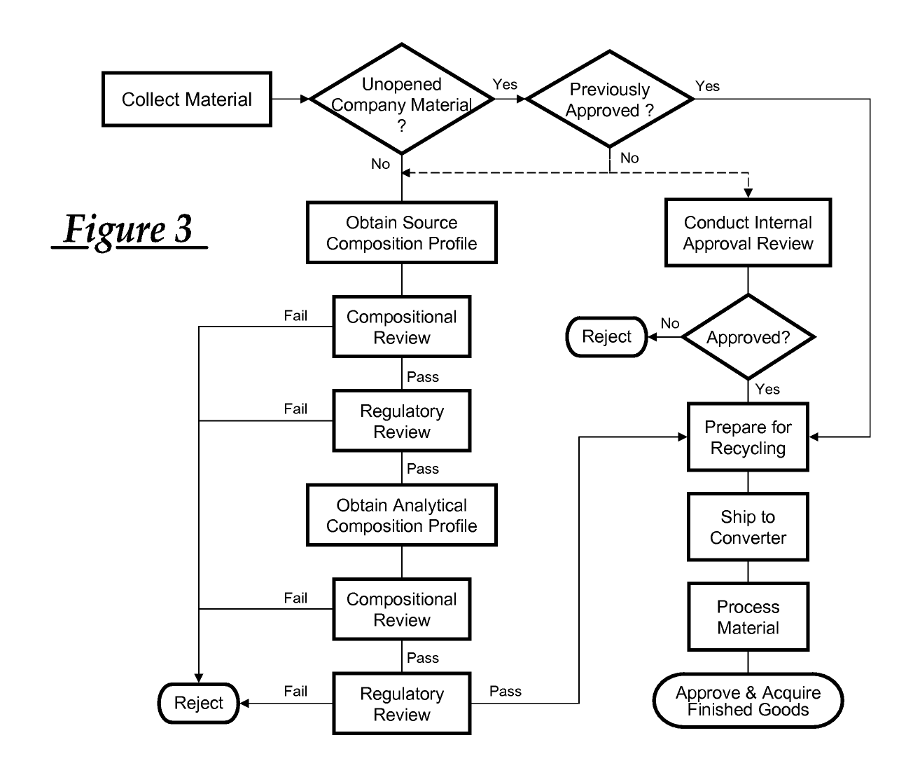

Referring now to FIG. 3, there is shown one embodiment of the stage 2 processing discussed above. This process would be used following the collection of scrap and/or waste silicone from one or more sources. Also, like the structure and processing shown in FIGS. 1 and 2, this embodiment is disclosed as it might be implemented by a silicone products manufacturing company; however, it will be appreciated by those skilled in the art that the overall recycling process could be run by an ESC or other third party. In general, the process involves collecting the scrap silicone material, validating it for recycling using an assessment procedure and, if the assessment demonstrates that the material is suitable for recycling into a usable silicone raw material, then proceeding to prepare the material for recycling, shipping it to a converter who then processes the material as noted above to generate the raw material that is then redistributed to one or more silicone consumers. The validation is described in detail below and generally involves performing a paper assessment of the material based on a documented source composition profile, then physically analyzing the material to obtain an analytical composition profile, followed by an analytical assessment based on the analytical composition profile. The initial collecting of the scrap material need only involve sufficient material to perform the physical analysis used to obtain the analytical composition profile, in which case, the complete supply of scrap material can then be collected after and only if the material is determined to be suitable by the paper and analytical assessments.

As shown in FIG. 3, the process of analyzing the scrap silicone can be carried out using different procedures depending upon the source and packaged condition of the silicone. Where the silicone comes from unopened containers of material supplied by the company itself, the composition will be known (and will have a product name), so that assessment of its suitability for conversion back to raw materials is dependent only on whether or not it is already on an “Approved List” of recyclable products. If so, then the scrap silicone can be prepared for recycling (e.g., packaged for shipment, aggregated with other silicones) and then distributed to one or more converters. If it has not been previously approved (i.e., not on the “Approved List”), then one of two alternative approaches can be taken, as indicated by the broken line in FIG. 3. Either the material can be put through the paper and analytical assessment testing, or the material can be submitted for an internal company approval review, in which case, if approved, the unopened material can be added to the “Approved List” and prepared for recycling and shipment to a converter. If not approved, then the material is rejected and is disposed, recycled, or re-used by other means. Internal company approval can be carried out using a material specialist either within the company or using an outside firm is contacted and used to assess the material for approval or denial of its suitability for conversion.

For other sources of material, including unopened supplies of material from other sources (not company material) and opened containers of material from the company or elsewhere, a material validation procedure is used due to the greater uncertainty in the material content. In general, the validation procedure involves a two-phase review that includes both the paper assessment and the analytical assessment, each of which will be described in greater detail below. Initially, a source composition profile is obtained, typically from the supplier or source of the waste silicone material. This source composition profile is the basis for the first phase paper assessment and, as such, can be supplied as a physical document, electronic file (text or image), or in any other suitable form. Although it is desirable that this composition profile includes a complete identification of the components and relevant properties of the material, the completeness and accuracy of the profile is not a certainty; thus, the process uses the second phase analytical assessment to help minimize the chance that the scrap silicone material has some contamination not identified in the source composition profile provided by the supplier. In this way, an initial paper assessment can be used to reject those materials that clearly are not suitable for the recycling process without incurring the added expense and effort of performing a physical analysis for each supply of scrap material and, for those materials that pass the paper assessment, the analytical assessment is then used to help insure that the material components and properties are fully known so that the ESC can fully determine whether the material is suitable for recovery of silicone usable as a raw material for one or more end uses.

Apart from receiving the source composition profile from the supplier itself, the source composition profile can be generated by the company or ESC based on available composition information for the material. This can be done by added the available description of the material's composition into a database of material samples and then generating a standardized source composition profile of the material, either before or as a part of incorporating it into the database. This can be done, for example, by using the database software or other program to provide the composition profile. This material composition profile can be standardized by the use of a predefined protocol or format for the identification of the material's constituent elements and, if desired, its properties. The specific content of the composition profile can depend on the type of material being recycled; for example, for silicones, the composition profile preferably includes not only all of the constituent components of the material, including components for which only trace amounts are included, but also various properties of the material such as its form (e.g., oil or rubber) and for liquids its flashpoint and possibly its viscosity. The composition profile preferably includes all of the information needed to determine (1) the material's compliance with regulatory requirements, (2) its suitability for recycling, and (3) its suitability for producing raw material that meets the quality specifications needed for particular end use products.

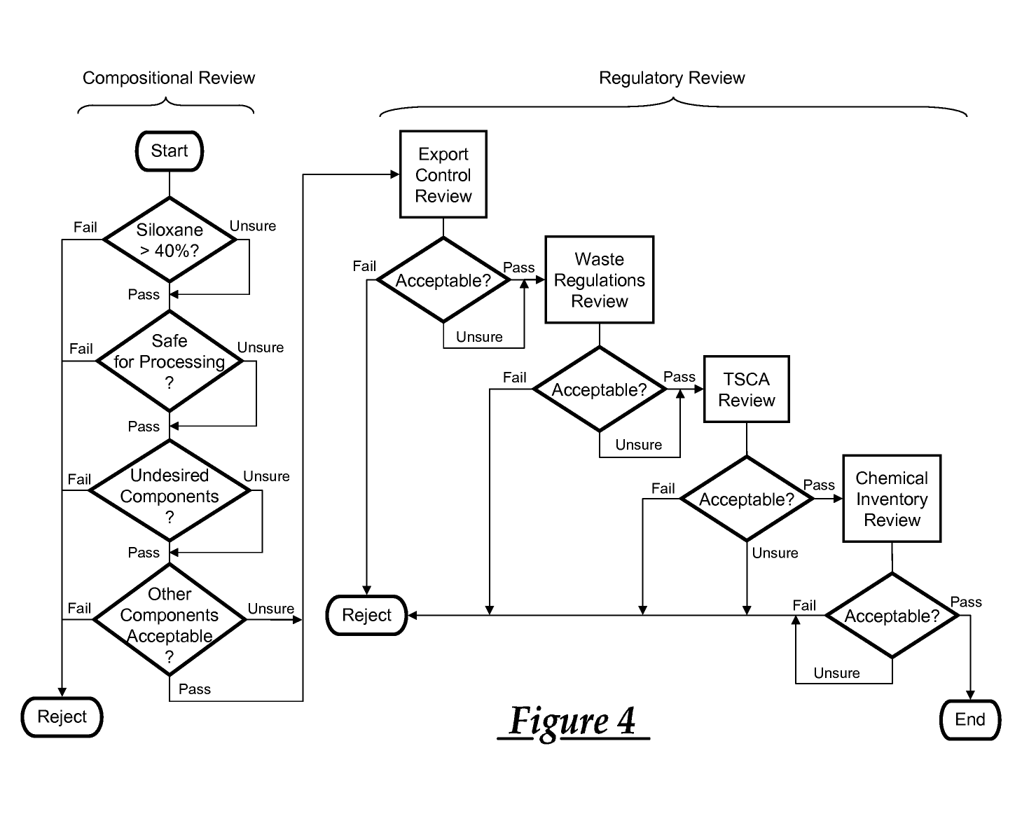

Continuing with FIG. 3, after obtaining the source composition profile, the paper assessment is carried out which, in general, involves two types of assessments—a compositional review and a regulatory review. Each of these two reviews involves one or more qualifying tests, each of which is used to determine a pass or fail result based on the source composition profile for the material. If any of the qualifying test outcomes is a fail result, then the material is rejected and the assessment and overall process halts. The compositional review is used to determine the suitability of the material for recycling into one or more end raw materials that meet the quality specifications required of one or more of a number of different end use products. The regulatory compliance review is used to determine whether the material meets any applicable governmental requirements as well as any desired applicable industry requirements. Further details of these two review processes and the qualifying tests used by them will be described further below in connection with FIG. 4.

Assuming the material passes both the compositional review and regulatory review on the basis of the source composition profile, the next step is to perform physical analysis of the material to generate a comprehensive analytical composition profile. Using this analytical composition profile, another compositional review and regulatory review are undertaken, and these two second phase reviews can use the same or different qualifying tests as used during the paper assessment. The analytical composition profile can include the same types of information as described above in connection with the source composition profile, and can be generated in a standardized format if desired. The analytical composition profile can also include other information either not available from the source composition profile or that is particular to a qualifying test used only in the analytical assessment phase. The specific profile information and qualifying tests will be dependent upon the particular industry and/or type of material being assessed. Again, if the qualifying tests for the material produce a fail result at any step in the assessment phases, the material is rejected and further assessment ends. In the event that both assessment phases conclude with the material passing all qualifying tests, the material is then prepared for recycling, shipped, converted, and acquired or distributed as finished raw material.

Turning now to FIG. 4, an embodiment of the compositional review and regulatory review used for both the paper and analytical assessments of FIG. 3 are shown. The process starts following acquisition of the source (phase 1) or analytical (phase 2) composition profile. For the compositional review, a series of the qualifying tests are carried out—four such tests in the example shown. First, the composition profile is checked to determine if the material has sufficient siloxane to be considered silicone that is suitable for catalyst cracking. If not, the material is rejected, but if the siloxane percentage is above the threshold requirement, then the process flows to the next qualifying test where a determination is made as to whether the material is safe for the recycling process. For example, a low flashpoint liquid or one that results in undesirable byproducts might be rejected at this point. The particular implementation of this test may depend upon the particular process used by a particular converter such that details of the conversion process for one or more converters can be maintained along with the samples database to provide convenient access to the relevant processing information. Assuming the material is not rejected at this point, the next qualifying test is for undesirable or unacceptable components such as hazardous components, etc. This test can include not only a check of whether a particular undesirable component is included, but the maximum acceptable amount, since while even trace amounts of some components may be a basis for rejection of the material, some undesirable components are still acceptable if below a specified percentage. Finally, if no unacceptable amounts of undesired components exists, then a review of any remaining components is made to determine whether they would adversely effect the conversion processing or prevent the end raw material from meeting the quality specifications required for a particular finished good. This can be done using a screening list of acceptable components and percentage amounts. If this qualifying test is also passed, then the process moves to the regulatory review.

As indicated by the check boxes of FIG. 4 for the compositional review, some of the qualifying tests may have an outcome that is unknown or “unsure”, in which case either a pass or fail result is selected for continued processing of the assessment. The particular result selected can be predetermined according to whether the unknown condition should cause the material to be rejected or not at this point in the assessment. For example, where the material is a liquid and, during the paper assessment, no flashpoint is available from the source composition profile, then the method involves selecting a “pass” result for the qualifying test that considers whether the material is safe for processing, and this is done because this flashpoint determination can be considered again during the analytical assessment. For the compositional review shown in FIG. 4, all of the unsure outcomes are given a pass result which would be useful in handling uncertain qualifying test outcomes in the paper assessment; however, for the analytical assessment one or more of the unsure outcomes could be predetermined to result in a fail result so that the material is rejected.

The regulatory review also includes a series of qualifying tests, beginning with an export control review. This can involve a check of whether the material is export controlled such that it cannot be sent outside the country to a foreign converter. Where exportation is not permitted, the material is rejected. If the material is acceptable for export to the particular country where the converter is located, then the next qualifying test is a review of waste regulations that are applicable to particular type of material. These regulations are typically governmental regulations, but could also be company or industry regulations. If the material is acceptable according to the waste regulations, then a TSCA (Toxic Substances Control Act) review is conducted. If the material is acceptable according to that TSCA qualifying test, then a chemical inventory review is conducted to determine whether the components of the material can all be imported by converter which, again, may be located overseas. If so, the assessment ends and the silicone material is prepared for transportation to the converter, as noted back in FIG. 3. If the import regulations are not met based on the chemical inventory review, the generator can be contacted to determine if it is willing to obtain importation approval and, if this is obtained, the silicone material is then prepared for transportation; otherwise, the material is rejected. As an example, in a situation where the supplier(s) of the scrap/waste silicone and the ESC are located in the U.S., and the converter is located in China, this chemical inventory review test could be used to determine whether all of the material's components are listed on China's Inventory of Existing Chemical Substances (IECSC). If so, the material can be sent to China for conversion. If not, then the supplier of the material is given an opportunity to get the unlisted component(s) added to the IECSC.

As will be appreciated by those skilled in the art, the above-described tests used for assessing the suitability of the material for recycling are not exhaustive, as other tests or criteria could be used. Similarly, some of these tests could be eliminated. For example, the tests for whether the material is restricted from importation or exportation would not apply where all of the recycling processing steps are carried out domestically. Similarly, where the process is used for materials other than silicones, the test for siloxane content would not be used.

For the qualifying tests used in the regulatory review, the unsure or unknown outcomes can be handled in a manner similar to that described above in connection with the compositional review. The example shown in FIG. 4 is also as these outcomes might be resolved during the paper assessment and it can be seen that some, such as the export control review, pass the material even where the outcome is uncertain, whereas others, such as the TSCA review, fail the material where the outcome is uncertain.

An advantage of the process described above is that it can be implemented and managed by a particular OEM products company not only as a way of obtaining recovered raw materials for use in its manufacturing operations, but also as a way of helping to ensure the quality and traceability of the recovered raw materials. For example, in testing to determine whether the material contains hazardous components, certain maximum acceptable levels of the various components can be predefined, and these maximum levels can be determined based on certain possible end uses of the material; for example, one end use might require a high grade of recovered material in which no detectable amounts of a particular contaminant are allowed, whereas another end use might have a certain ppm level of that contaminant that is acceptable. The types of contaminants that might form the basis for rejected a particular supply of silicone waste are known to those skilled in the art. By managing the recycling process from the initial identification and collection of scrap/waste silicone to the conversion and return of the recycled raw materials, the manufacturer can ensure the quality of the recycled material it receives and can tie particular supplies of silicone scrap/waste to particular end uses. This gives the manufacturer the ability to select certain waste streams from one or more generators based on the demands of certain recycled materials or their end uses.

It is to be understood that the foregoing description is not a definition of the invention itself, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, apart from creating a material composition profile, the materials can be categorized into groups based on their compositions and/or properties, and this grouping can be used to define one or more subsets of the various recovered silicones that may be suitable for certain end use applications. Also, the order of the compositional and regulatory reviews, as well as the various qualifying tests used by each, can be different than as shown. All such other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of validating a material for recycling into a least one raw material, comprising the steps of:
(a) collecting the material from one or more sources;
(b) determining suitability of the material for processing using a series of qualifying tests separated into a two-phase review, wherein each of the qualifying tests involves determining at least a pass or fail result based on a composition profile for the material;
wherein a first phase of the two-phase review includes the steps of:
(c1) obtaining a source composition profile for the material;
(c2) assessing regulatory compliance for the material based on the source composition profile; and
(c3) assessing acceptability of the material components based on the source composition profile; and
wherein a second phase of the two-phase review includes the steps of:
(d1) obtaining an analytical composition profile for the material based on a physical analysis of the material;
(d2) assessing regulatory compliance for the material based on the analytical composition profile; and
(d3) assessing acceptability of the material components based on the analytical composition profile; and
(e) rejecting the material for processing if a fail result is determined by any of the qualifying tests and, if no fail result is obtained, then passing the material as validated and suitable for processing.

2. The method set forth in claim 1, wherein step (c1) comprises obtaining a documented source composition profile for the material from the one or more sources.

3. The method set forth in claim 1, wherein steps (c2) and (c3) each involve at least one qualifying test using the source composition profile, and wherein steps (d2) and (d3) each involve at least one qualifying test using the analytical composition profile.

4. The method set forth in claim 3, wherein at least some of the qualifying tests used in the first phase involve an outcome that cannot be determined based on content of the source composition profile and wherein the method further includes selecting a pass or fail result for the qualifying test when the outcome cannot be determined.

5. The method set forth in claim 1, wherein steps (c2) and (d2) comprise conducting a plurality of the qualifying tests including a TSCA review, export review, and waste regulation review.

6. The method set forth in claim 1, wherein steps (c3) and (d3) include a first qualifying test that involves determining if the material contains a sufficient amount of at least one desired material needed for obtaining the raw material(s) and a second qualifying test that involves determining if the material contains unacceptable amounts of any of a number of specified undesirable components.

7. The method set forth in claim 6, wherein steps (c3) and (d3) include a third qualifying test that involves determining if the material contains any of a number of acceptable components that do not adversely effect either recycling of the material or the raw material(s) resulting from the recycling.

8. The method set forth in claim 1, wherein step (d1) comprises obtaining the analytical composition profile by physical analysis of the material.

9. The method set forth in claim 1, wherein at least one of the composition profiles include an identification of the constituents of the material and one or more properties of the material.

10. A method of recycling material comprising the steps of validating the material using the method of claim 1 and, if not rejected, then (f) distributing the material to at least one material converter for processing, (g) converting the material to one or more raw materials, and (h) distributing the raw material(s) to at least one material consumer.

11. A method of recycling a material to obtain at least one recycled component suitable for use in a predetermined end product, comprising the steps of:
collecting the material;
assessing the material using a plurality of qualifying tests at least one of which is carried out according to one or more requirements relating to the predetermined end product;
obtaining from the material at least one component usable in the predetermined end product based on the outcome of the qualifying tests; and
producing the predetermined end product using the component.

12. The method set forth in claim 11, wherein the material comprises scrap or waste silicone.

13. The method set forth in claim 11, wherein the step of assessing the material comprises a two-phase review including a first phase that uses a source composition profile and a second phase that uses an analytical composition profile.

14. The method set forth in claim 13, further comprising the step of generating the analytical composition profile by physical analysis of the material.

15. The method set forth in claim 11, wherein the obtaining step further comprises recycling the material using a conversion process that produces the component.

16. A method of recycling silicones comprising:
collecting scrap silicone;
assessing the scrap silicone for the presence of a sufficient siloxane content, safety for recycling, the presence of a hazardous component and the potential for an unusable byproduct in a conversion process;
converting the scrap silicones to form a reusable component with a predetermined profile; and
reusing the reusable component.
